(19) United States
(12) Patent Application Publication
(10) Pub. No.: US 2008/0212801 A1
(43) Pub. Date: Sep. 4, 2008

(54) Amplifier for Musical Instruments, Particularly a Guitar Amplifier

(75) Inventor: Bernd Schneider, Altenkirchen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Stamer Muslkanlagen GmbH, St. Wendel (DE)

(21) Appl. No.: 11/660,262

(22) PCT Filed: Jul. 29, 2005
(86) PCT No.: PCT/EP05/08260

§ 371 Date: Sep. 28, 2007

(30) Foreign Application Priority Data
Aug. 26, 2004 (DE) 20 2004 013 398.9

(51) Int. Cl. G10H 1/00

(52) U.S. Cl. 381/118

(57) ABSTRACT

The invention relates to an amplifier for musical instruments, particularly a guitar amplifier, comprising at least one channel and at least one electronic memory for set parameter values such as delay, reverb, chorus, flanger, tremolo, treble, middle, bass, volume and the like. According to the invention, means are provided with which the storage of the parameter values of at least one channel, preferably of all channels, can be automatically carried out.

### CROSS-REFERENCE TO RELATED APPLICATIONS

This application is a National Stage of International Application No. PCT/EP2005/008260, filed Jul. 29, 2005, and which claims the benefit of German Patent App. No. DE 20 2004 013 398.9, filed Aug. 26, 2004. The disclosures of the above applications are incorporated herein by reference.

### FIELD

The invention relates to an amplifier for musical instruments, in particular to a guitar amplifier, comprising at least one channel and at least one electronic memory for set parameter values such as delay, reverb, chorus, flanger, tremolo, treble, mid, base, channel volume, total volume and the like.

### BACKGROUND

The statements in this section merely provide background information related to the present disclosure and may not constitute prior art.

Amplifiers for musical instruments, in particular for guitars, generally have at least two channels with respectively different amplification properties for the generation of amplified signals with different timbres. A musician selects one of the channels depending on the style of music and the desired sound, with frequently a change taking place to and fro between the channels even when playing a single piece of music.

When the user has selected a channel with his preset sound properties, he frequently would still like to make fine adjustments or set specific sound effects.

With classical amplifiers, specific sound effects can be achieved by integrated analog effect devices which are controlled with the help of controls provided on the amplifier. If the amplifier has a plurality of channels, either separate effect controls are provided in each case for each channel, which has the disadvantage of a lack of clarity, or common controls for a plurality of channels are used which each control the settings of the just active channel. In the latter case, these set parameter values are, however, lost on a change of the channel when the musician makes new settings for the new channel. In practice, the preferred parameter values for each channel are noted down on a note with such an amplifier in order to be able to restore them fast on a repeat change of channel. This method is not only imprecise, but also time-consuming and uncomfortable.

Today, with modern electronic amplifiers, the sound effects previously made in analog can be generated with the aid of a digital signal processor. With digital amplifiers, not only these sound effects, but rather the total sound, is generated via a computer. In this case, a storing of set parameter values, such as the volume or the pitch, can likewise take place digitally without problem.

However, due to the better sound quality, analog amplifiers frequently continue to be used in which the sound itself is generated in a conventional manner via a tube or transistors. Such analog amplifiers can, however, likewise have a digital signal processor which is used to generate additional sound effects such as echo, reverb, flanger, tremolo and the like. New solution approaches have thus also resulted for the problem of the storage of parameters set for a channel in comparison with amplifiers with an analog effect generation.

For example, analog guitar amplifiers are thus already on the market with integrated digital signal processors for the generation of sound effects which have an electronic memory for the storage of such set parameter values. Generally, the set parameter values can be stored in the electronic memory in that a storage process is triggered manually—for example by pressing a corresponding button. A musician can thus set and store the desired parameter values for the individual channels, for example, during a rehearsal.

The musician would, however, frequently like to change the settings while playing, for example to match the sound to a specific piece of music or because different acoustic conditions prevail than, for example, at a preceding rehearsal. In this case, he will therefore change the parameter values while playing and thus usually under pressure of time. With the conventional amplifiers, the user now first always has to trigger a memory procedure before a change of channel in order to store the newly set parameter values of the first channel when he wants to find the same parameter values again on another change of channel back to the first channel. The manual triggering of the storage process requires time and additional concentration and is easily forgotten. In these case, the settings made are lost, which in another respect also happens with the conventional analog electronic amplifiers on the switching off of the amplifier or on an interruption to the power supply if a memory procedure was not previously triggered manually. The parameter values must then be set again.

### SUMMARY

It is therefore an object of the present invention to provide an amplifier of the aforesaid type which minimizes the time effort required for the setting and storing of the parameter values and reduces the possibility of a data loss.

This object is satisfied in accordance with the invention in that means are provided by which the storage of the parameter values of at least one channel, preferably of all channels, can be carried out automatically. It is thus ensured that set parameter values are not lost unintentionally, but are again available when the device is switched back on or on the return to the respective channel. The additional step of the manual triggering of a storage process is omitted, whereby the operation is made substantially easier for the musician. The amplifier in accordance with the invention thus behaves so-to-speak like a classical amplifier with potentiometers or similar means, wherein the set values are maintained solely by the switch position or the switch state.

The means can be made so that a storage takes place on the change of the channel. In this manner, a data loss is avoided on switching from one channel to another channel.

Alternatively or additionally, the means can be made such that a storage takes place on an interruption to the voltage supply. It is thus prevented that the previously set parameter values are lost when the amplifier is switched off or when a power cut occurs.

Very generally, the means are preferably configured such that a storage always takes place on an impending loss of the parameter values.

In accordance with a further preferred embodiment of the invention, an automatic storage always takes place after the setting of the respective parameter values. Parameter values are thereby at no time set, but not stored, so that no settings can be lost even with a sudden power cut.

At least one parameter setting control is preferably provided which is simultaneously associated with two or more channels and is effective for the respectively selected channel. The total number of controls is thereby reduced, which increases the user friendliness and the clarity. The musician, who is usually under pressure of time when he wants to change a parameter value while playing, will find the right control quickly and an error is substantially less probable than with respective separate controls for every single channel.

In accordance with a preferred embodiment of the invention, controls associated in each case with only one channel are additionally provided for the setting of at least one further parameter value. These controls can, for example, be classical potentiometers for the setting of the volume, the gain and/or the sound, in particular for the control of the selective amplification of treble, mid and base. For example, an individual volume control and one or more sound controls can be provided in each case for each channel. The corresponding parameter values are then not stored electronically, but are maintained simply by the switch position of the controls.

In this embodiment, the means for the automatic storage of parameter values can accordingly be used only for the parameter values which relate to additional sound effects. A respective operating element, for example a rotary control, is provided for different settable sound effects such as reverberation effects, so-called reverb, echo effects, so-called delay, or chorus, flanger and tremolo. The respective setting of the respective parameter value for the instantaneously active channel is changed by the actuation of this operating element. On a change of channel, this setting is stored automatically and an actuation of the same operating element now has an effect on the newly set active channel.

In accordance with a further preferred embodiment of the invention, at least one clean channel and at least one overdrive channel is provided. In this case, common sound controls can be provided for a plurality of overdrive channels with which a corresponding number of different equalizer circuits are associated which are automatically switched with the overdrive channels. The clarity is again increased by this action since one manages with fewer controls overall.

Further areas of applicability will become apparent from the description provided herein. It should be understood that the description and specific examples are intended for purposes of illustration only and are not intended to limit the scope of the present disclosure.

### DRAWINGS

The invention will be described in more detail purely by way of example in the following with reference to a preferred embodiment and to the enclosed Figure.

FIG. 1 shows a frontal view of the upper part of an amplifier in accordance with the invention combined with a loudspeaker, a so-called combo.

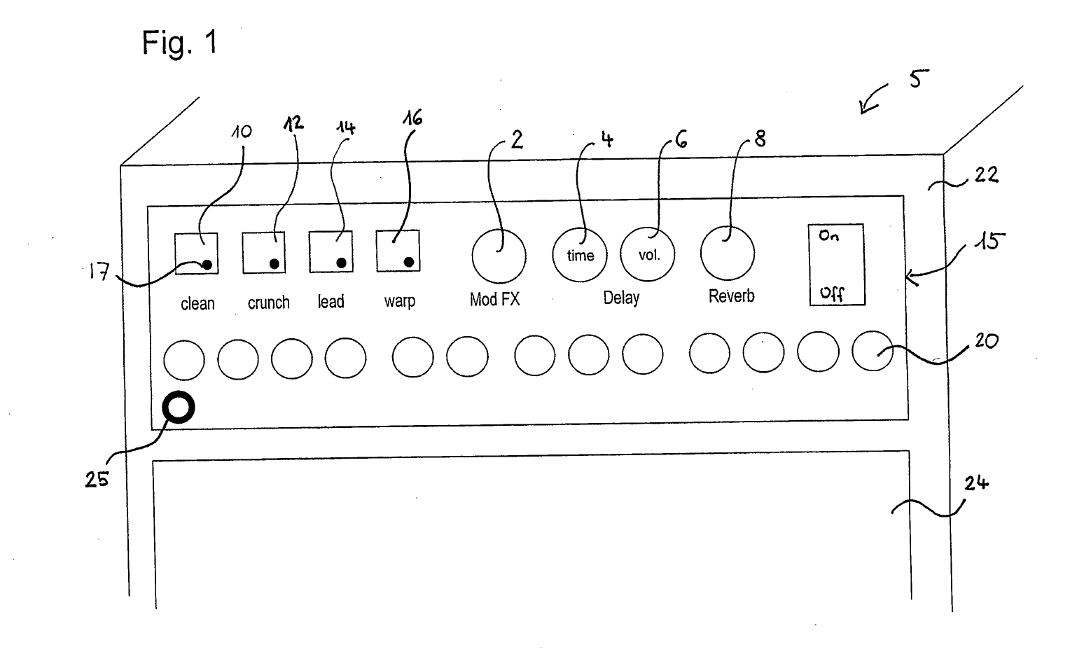

### DETAILED DESCRIPTION

The following description is merely exemplary in nature and is not intended to limit the present disclosure, application, or uses. It should be understood that throughout the drawings, corresponding reference numerals indicate like or corresponding parts and features.

The housing 5 of the combo shown with the amplifier in accordance with the invention has a loudspeaker region 24 at its front side and an operating panel 15 above the loudspeaker region. It is a guitar amplifier to which an electrical guitar can be connected at an input socket 25.

The input signal is first amplified as usual by a pre-amplifier—so-called gain. Subsequently, individual frequency ranges, namely treble, mid or base, can be raised or lowered by an equalizer and the signal can be processed by a digital signal processor which can generate different sound effects. An analog end stage amplifies the signal obtained in this manner and transmits it to the integrated loudspeaker and possibly to additional external loudspeakers. The actual amplification is generated in analog form in a known manner. It is of no significance for the invention whether this is a valve tube amplifier or a transistor amplifier and the actual amplification will therefore not be looked at in any more detail in the following.

As can be recognized in the Figure, four buttons 10, 12, 14, 16 are attached to the top left of the operating panel 15 which are associated with four different basic sound channels of the amplifier, namely a clean channel as well as three overdrive channels “crunch”, “lead” and “warp”. The respective channel is selected by pressing a button 10, 12, 14, 16. The channels each have different timbres, in particular distortions, which are inter alia generated by an overdrive of the pre-amplifier and/or of the end stage. A control unit switches to the corresponding settings depending on which channel is selected.

A footswitch, not shown, can be connected to the amplifier and permits a selection of the channel by pressing down a foot button, with a foot button being associated with each of the buttons 10, 12, 14, 16. The buttons 10, 12, 14, 16 each have a light emitting diode 17 which indicates whether the respective channel is active—diode lights up—or not, which is in particular helpful with a connected footswitch.

Four rotary effect controls 2, 4, 6, 8 are located to the right of the four buttons 10, 12, 14, 16 for the selection of the channel and serve for the setting of parameter values which serve as input values for the digital signal processor. The left-hand control 2 serves for the setting of a chorus effect, flanger effect or tremolo effect. The two middle controls 4, 6 serve for the setting of an echo effect—so-called delay—with the delay time being able to be set using the one control 4 and the volume of the delayed signal in relation to the original signal being able to be set using the second control 6. The right-hand control 8 serves for the setting of a reverberation effect, so-called reverb. If one of these controls 2, 4, 6, 8 is actuated, the respective parameter value for the respectively active channel is changed with immediate effect.

If the channel is now quit or if the device is switched off, the set parameter values are automatically stored in a non-volatile memory, for example an EEPROM memory. The storage process takes place within a time period of some 100 ms, during which the parameter values are still maintained by a suitable tracking circuit to avoid a data loss. The effects are generated by the digital signal processor which is in turn controlled by the control unit which polls the current setting of the controls 2, 4, 6, 8 or which polls the parameter values stored for the respective channel after a change of channel or after the device is switched off.

A series of controls 20 are furthermore provided in a lower region of the operating panel 15 which serve for the setting of further parameter values for the individual channels, with the control taking place not via the digital signal processor, but in an analog manner. An individual volume control in the form of a potentiometer is thus provided for each of the channels and a respective gain control and three common sound controls—treble, mid, bass—for the three overdrive channels. The sound matching each overdrive channel is generated via equalizer circuits switched automatically with the channel. Separate sound controls are provided, in contrast, for the clean channel.

The guitarist can now change the intensity, the volume and/or the sound—treble/mid/base—of the respective channel with the help of one of the controls 20, for example, while a specific channel is selected. This setting also remains “stored” on a change of channel due to the mechanical position of the control 20 and is available again on a repeated change back to this channel. In addition, the user can select different effects or change their properties with the help of the rotary effect controls 2, 4, 6, 8. In this connection, he always operates the same control for a specific effect irrespective of which channel is active at this point in time so that a clear number of effect controls is sufficient. When the guitarist now changes the channel with the help of the footswitch or by pressing one of the buttons 10, 12, 14, 16, the settings of the parameter values belonging to the controls 2, 4, 6, 8 are automatically stored in the EEPROM memory. If he later changes back into this channel, the values are automatically called up again by the control unit and are communicated to the digital signal processor as input values. The set values are likewise stored on switching off or in the event of a power cut. A storage can, however, also always take place when a parameter value is set as new. In this case, a tracking circuit can be dispensed with.

The description is merely exemplary in nature and, thus, variations that do not depart from the gist of the present disclosure are intended to be within the scope of the invention. Such variations are not to be regarded as a departure from the spirit and scope of the present disclosure.

### REFERENCE NUMERAL LIST

2, 4, 6, 8 controls for sound effects
5 housing
10, 12, 14, 16 buttons for the channel selection
15 operating panel
17 light emitting diode
20 controls for individual channels
22 housing front
24 loudspeaker region
25 input socket

1-10. (canceled)

11. An amplifier for musical instruments, comprising:
at least one analog channel;
an electronic memory for set parameter values such as delay, reverb, chorus, flanger, tremolo, treble, mid, bass, channel volume, total volume and the like; and
means for automatically storing parameter values of at least one channel.

12. An amplifier in accordance with claim 11, wherein the means are made such that storage takes place on the change of the channel.

13. An amplifier in accordance with claim 11, wherein the means are made such that storage takes place upon an interruption to the voltage supply.

14. An amplifier in accordance with claim 11, wherein the means are made such that storage takes place upon an otherwise impending loss of the parameter values.

15. An amplifier in accordance with claim 11, wherein the means are made such that storage takes place after a change to a parameter value.

16. An amplifier in accordance with claim 11, further comprising at least one parameter setting control (2, 4, 6, 8), which is simultaneously associated with a plurality of channels and is effective for a respectively selected channel.

17. An amplifier in accordance with claim 11, further comprising controls (20) for the setting of at least one further parameter value, which is only associated with one channel.

18. An amplifier in accordance with claim 17, wherein parameter setting controls (2, 4, 6, 8) associated with a plurality of channels control sound effects such as delay, reverb, chorus, flanger, tremolo and the like and the controls (20) control at least one of volume, gain and sound.

19. An amplifier in accordance with claim 11, further comprising a clean channel and at least one overdrive channel.

20. An amplifier in accordance with claim 19, wherein a plurality of overdrive channels are provided and have common sound controls, with which a corresponding number of different equalizer circuits are associated that are switched automatically with the overdrive channels.
